(19) United States
(12) Patent Application Publication
(10) Pub. No.: US 2023/0338220 A1
(43) Pub. Date: Oct. 26, 2023

(54) POWERED ORTHOTIC DEVICE FOR HAND EXTENSION AND METHODS OF USE THEREOF

(71) Applicants: BioVentures, LLC, Little Rock, AR (US); Arkansas Children's Hospital Research Institute, Inc., Little Rock, AR (US)

(72) Inventors: Tara Johnson, Little Rock, AR (US); Timothy Strasser, Little Rock, AR (US); Landon Burcham, Little Rock, AR (US); Jacob Scott, Little Rock, AR (US); Ricardo Meza, Little Rock, AR (US)

(21) Appl. No.: 17/673,323

(22) PCT Filed: Aug. 14, 2020
(86) PCT No.: PCT/US2020/046450

§ 371 Date: Feb. 16, 2022

Related U.S. Application Data
(60) Provisional application No. 62/888,172, filed on Aug. 16, 2019.

(51) Int. Cl. A61H 1/02

(52) U.S. Cl. CPC A61H 1/0288; A61H 2201/0207; A61H 2201/1638; A61H 2201/0107; A61H 2201/169; A61H 2201/0228; A61H 2201/5007

(57) ABSTRACT

An automated therapeutic device and methods thereof for heating and extending a patients curled fingers is provided. The device includes a rigid base extending from a patients hand to elbow, a plurality of fingerlets, each operable to attach to a finger of the patient, a plurality of extending elements, each extending element operable to reversibly attach to the rigid base and reversibly attach to one of the plurality of fingerlets, and a heating element operable to reversibly attach to the rigid base and distribute heat along the patient's anterior forearm.

### CROSS-REFERENCE TO RELATED APPLICATIONS

This application claims the benefit of priority of U.S. Provisional Patent Application No. 62/888,172, filed on Aug. 16, 2019, the disclosure of which is hereby incorporated by reference in its entirety.

### FIELD

The present disclosure is directed to powered orthotic devices for hand extension. In at least one example, the present disclosure relates to an automated therapeutic device for heating and extending a patient's curled fingers.

### BACKGROUND

Patients with Cerebral Palsy and other neuromuscular conditions often experience hypertonia, a muscular condition that causes affected muscles to become tense. The tension causes pain and can often render the muscles ineffective for normal use. Most patients undergo extensive therapy to mitigate the pain and to regain mobility in the affected muscles.

Most therapies for hypertonicity in the hands and fingers include using splints to reduce the return of muscle tone between appointments with a physical therapist. Static splints use stretching forces to force the patient's hand into a static position for long periods of time. However, using these splints may lead to joint deformation, muscular atrophy, and pressure sores, while doing little to improve the patient's mobility. Alternatively, dynamic splints use resistive forces to counteract contractions of the patients' hand and avoid the harmful side effects that static splints may cause. However, no known device uses extending elements to act as pseudo-fingers while simultaneously providing therapeutic heat to help alleviate pain and improve mobility. As presented herein, an automated therapeutic device may provide for optimal heating and extending of a patient's curled fingers.

### BRIEF SUMMARY

Provided herein is an automated therapeutic device for heating and extending a patient's curled fingers. The device may include a rigid base that extends from the patient's hand to the patient's elbow, a plurality of fingerlets, each operable to attach to one of the patient's fingers, a plurality of extending elements, each operable to reversibly attach to the rigid base and reversibly attach to one of the plurality of fingerlets, and/or a heating element operable to reversibly attach to the rigid base and to distribute heat along the patient's forearm.

Further provided herein is a method for extending a patient's curled fingers and therapeutically applying heat to the patient's forearm. The method may include placing an automated therapeutic device on a patient's hand, supplying power to the device, where the amount of power supplied is sufficient to cause the extending elements to extend the patient's fingers. The automated therapeutic device may include a rigid base that extends from the patient's hand to the patient's elbow, a plurality of fingerlets, each operable to attach to one of the patient's fingers, a plurality of extending elements, each operable to reversibly attach to the rigid base and reversibly attach to one of the plurality of fingerlets, and a heating element operable to reversibly attach to the rigid base and to distribute heat along the patient's forearm.

Other aspects and iterations of the invention are described more thoroughly below.

### BRIEF DESCRIPTION OF THE DRAWINGS

The description will be more fully understood with reference to the following figures and data graphs, which are presented as various embodiments of the disclosure and should not be construed as a complete recitation of the scope of the disclosure, wherein:

FIG. 1 shows an example of the disclosed automated therapeutic device.

FIG. 2 shows a fingerlet and an example of its dimensions.

FIG. 3 shows a fingerlet placed on a patient's finger in one example.

FIG. 4 shows a disk magnet attached to a fingerlet in one example.

FIG. 5 shows an example of the automated therapeutic device that includes an elastic strap across the patient's palm.

FIGS. 6A-6B show a forearm strap connecting the rigid base to the heating element. FIG. 6A shows the posterior view of the forearm strap. FIG. 6B shows the medial view of the forearm strap.

FIG. 7 shows example button snaps.

FIG. 8 shows a plurality of straps useful for bundling wires connected to the extending elements in one example.

FIG. 9 shows the portion of the rigid base that is worn on the patient's wrist in one example.

FIG. 10 shows a rigid base that has been molded to fit a patient's arm in one example.

FIGS. 11A-11B show the portion of the rigid base that is worn on the patient's forearm in one example. FIG. 11A shows the posterior view of the rigid base. FIG. 11B shows the anterior view of the rigid base.

FIGS. 12A-12B show a heating element inserted into a thermal pouch in one example. FIG. 12A shows a heating element inserted into a thermal pouch. FIG. 12B shows a heating element inserted into a thermal pouch.

FIG. 13 shows the materials included in an example extending element including a shape memory alloy coiled in a resistance heating wire, silicone tubing, and perforated neoprene, as well an example of a device including four extending elements in an example.

FIG. 14 shows an example configuration of the heating element including the configuration of the resistance heating wire and placement of the resistance temperature indicator.

FIG. 15 shows an example of an electrical system useful to operate the automated therapeutic device.

FIGS. 16A-16B show a lateral view of the extending elements in one example. FIG. 16A shows the position extending elements before the device has been activated. FIG. 16B shows the position of the extending elements after the device has been activated and the extending elements are fully extended.

FIGS. 17A-17C shows the same fingerlet placed on fingers of differing widths.

FIG. 19A shows the fingerlet placed on a finger 0.5 inches in diameter. FIG. 19B shows the fingerlet placed on a finger 0.55 inches in diameter. FIG. 19C shows the fingerlet placed on a finger 0.60 inches in diameter.

FIG. 18 shows a patient wearing the device and the relative dimensions of the device to the patient's forearm in one example.

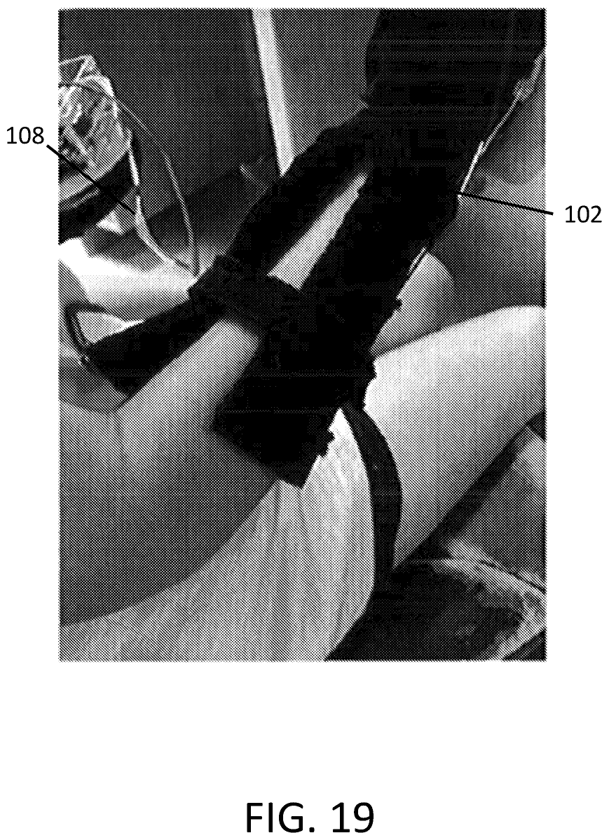

FIG. 19 shows a patient wearing the device in one example.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout the above disclosure will now be presented. The terms “coupled” or “attached” defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, “substantially cylindrical” means that the object resembles a cylinder, but can have one or more deviations from a true cylinder. The terms “comprising,” “including” and “having” are used interchangeably in this disclosure. The terms “comprising,” “including” and “having” mean to include, but not necessarily be limited to the things so described.

Provided herein is a device used to extend the curled fingers of a patient suffering from neuromuscular disorders including hypertonic cerebral palsy, while also providing therapeutic heat to the patient's forearm. In some examples, the device may include a rigid base extending from a patient's hand to elbow, a plurality of fingerlets, each operable to attach to a finger of the patient, a plurality of extending elements, each extending element operable to reversibly attach to the rigid base and reversibly attach to one of the plurality of fingerlets, and a heating element operable reversibly attach to the rigid base and distribute heat along the patient's anterior forearm.

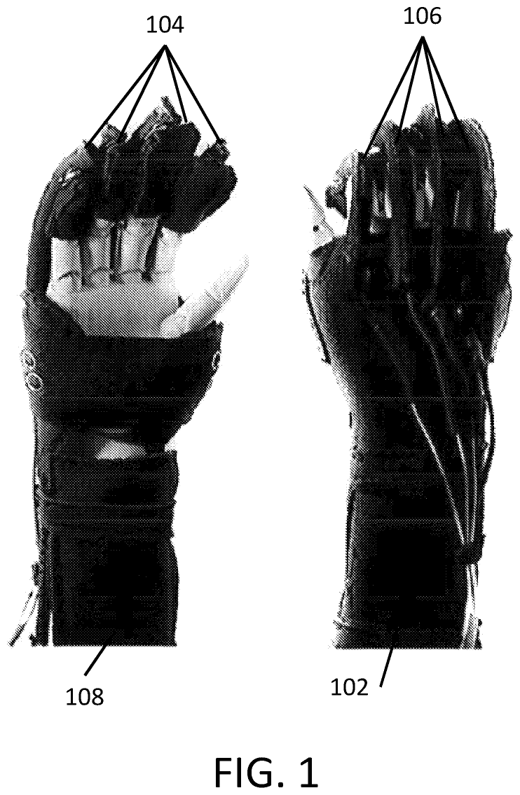

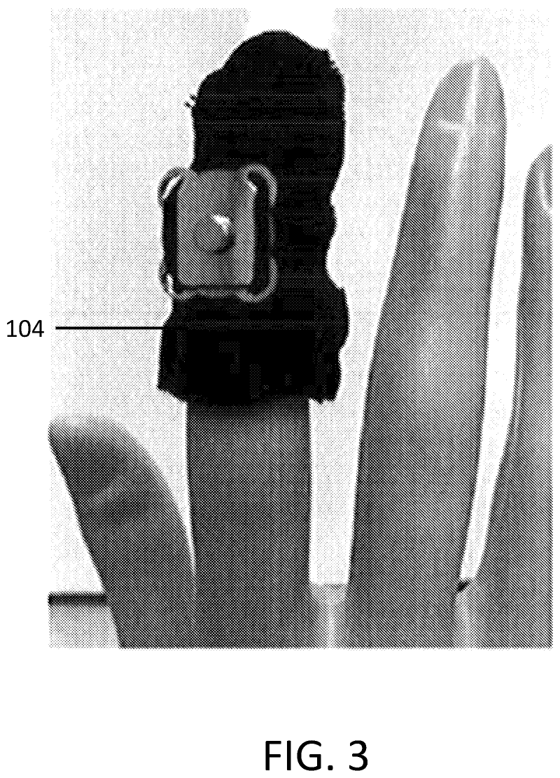

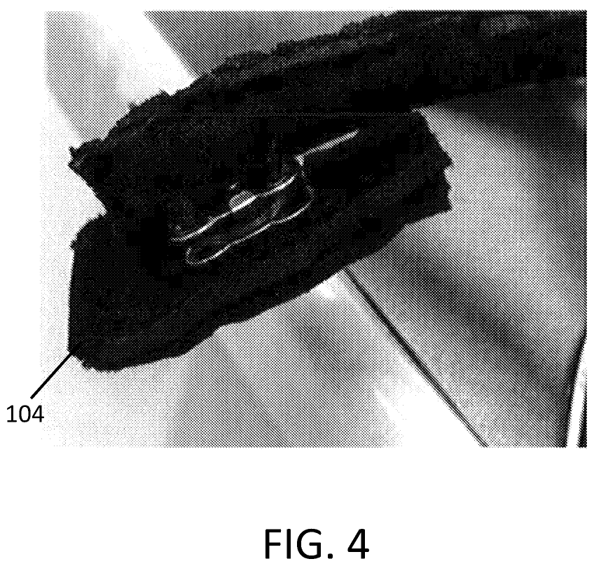

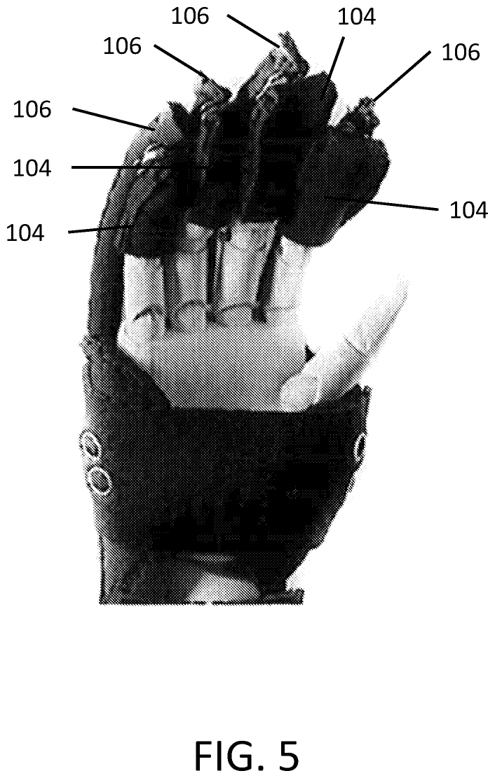

As seen in FIGS. 1-5, the device may include a rigid base 102 worn on the patient's forearm and hand as well as a plurality of fingerlets 104 which are worn on the patient's fingers. A plurality of extending elements 106 connects each of the fingerlets to the rigid base. In an example, the extension may be accomplished by using a shape memory alloy, which becomes straight and rigid when heat is applied to the alloy. Additionally, the device includes a heating element 108 that supplies heat to the patient's forearm.

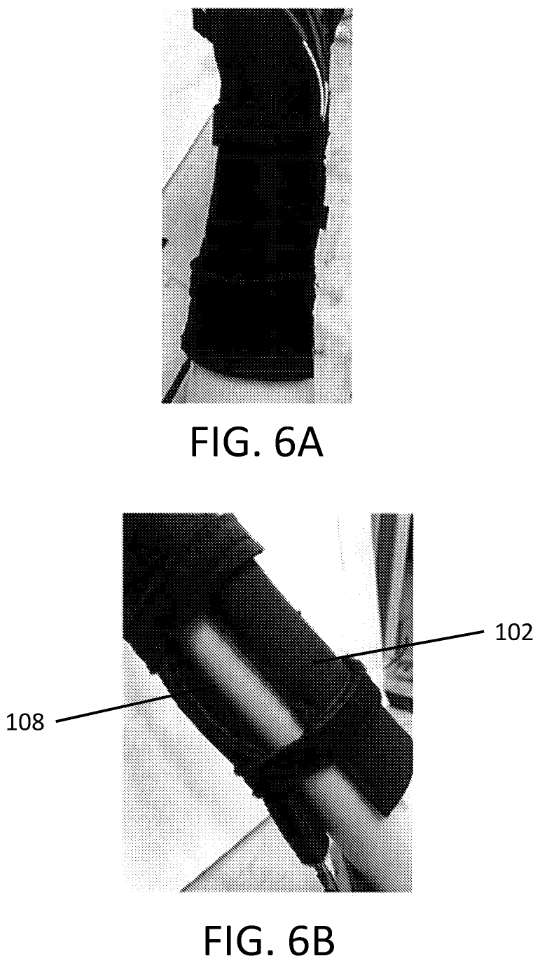

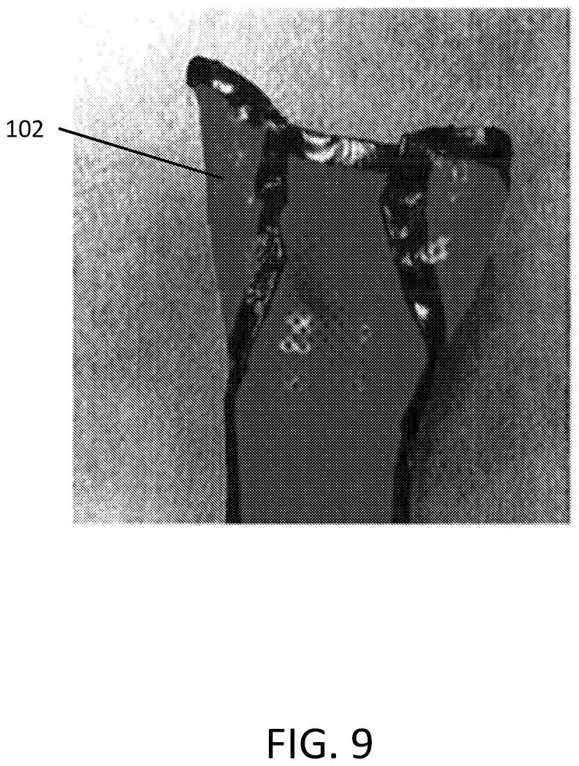

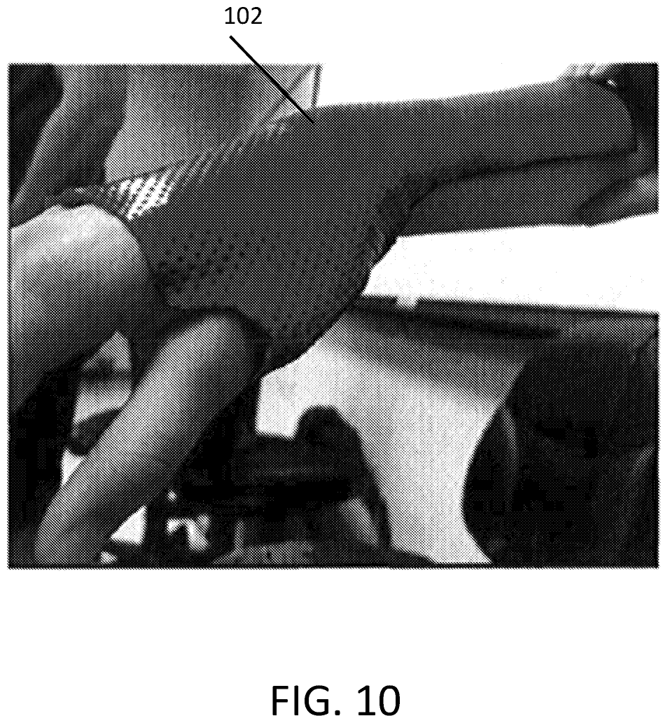

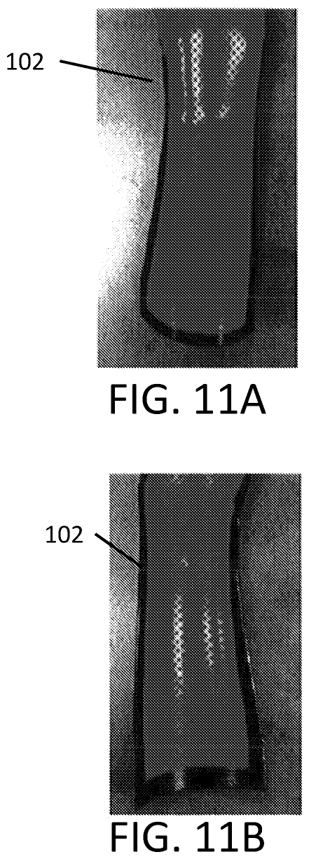

As seen in FIGS. 6A-6B, 9-11B and 18-19, the rigid base 102 extends from the patient's hand to the patient's elbow. In some examples, the rigid base covers the posterior side of the patient's hand and forearm, but leaves the anterior side of the patient's forearm and palm exposed to receive heat from the heating element 108. Further, the rigid base may terminate at the distal end of the posterior palmar region of the patient's hand. The rigid base may have a length approximately the length of the patient's forearm. In some examples, the rigid base may be about 4 inches, about 5 inches, about 6 inches, about 7 inches, about 8 inches or about 10 inches long. In at least one example, the rigid base may be about 6-8 inches in length. In one example, the rigid base 102 is made of a thermoplastic material that may be shaped to fit the forearm of the patient using the device. In another example, the thermoplastic material may be perforated and a layer of perforated neoprene may be sewn onto the rigid base to give it a sleek appearance. The rigid base 102 may be held to the patient's hand by using an elastic strap which stretches across the anterior palmar region of the patient's hand. In one example, this elastic strap may be attached to the rigid base 102 with button snaps.

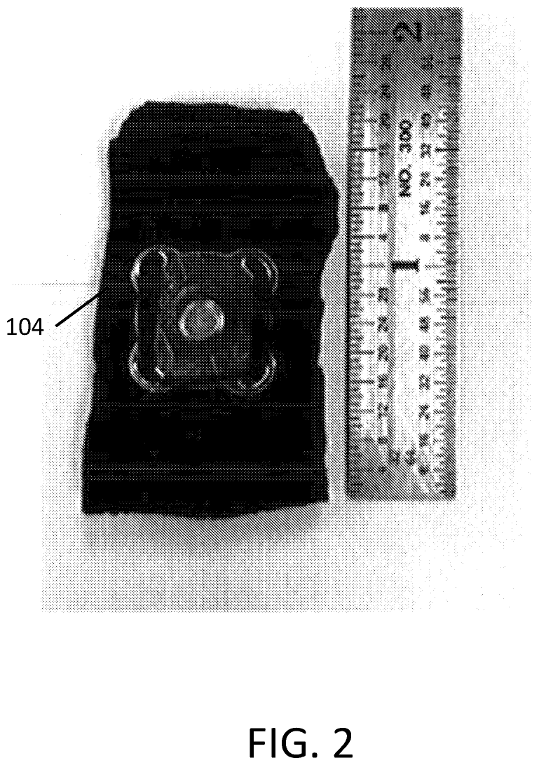

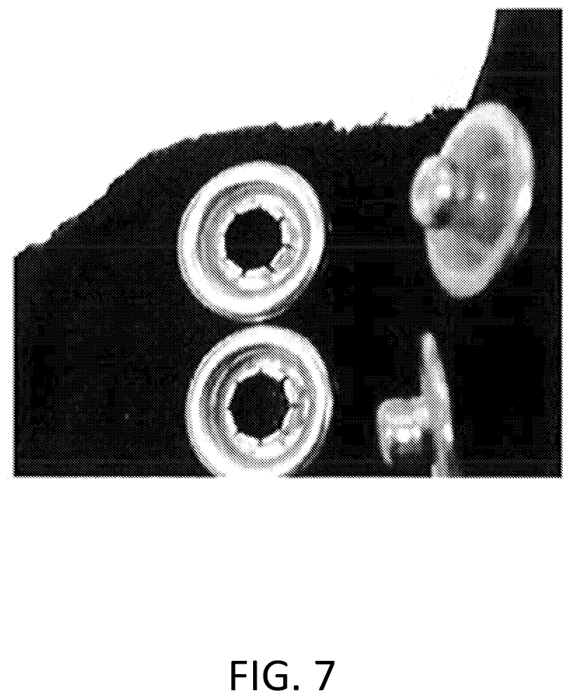

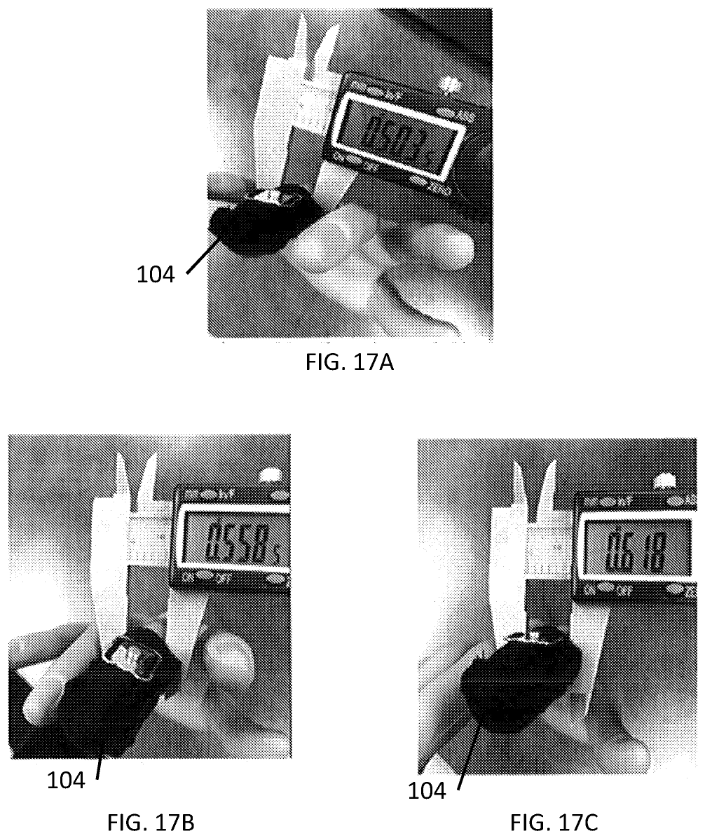

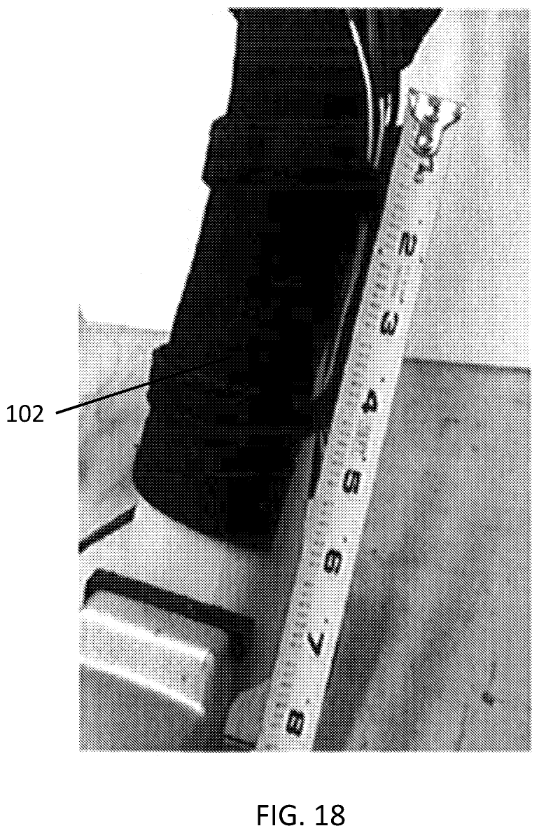

As seen in FIGS. 2-4 and 17A-17C, the device further includes a plurality of fingerlets 104, each of which is operable to attach to a finger of the patient. In at least one example, this may be accomplished using an elastic perforated neoprene material that wraps around each finger. This type of material may allow the fingerlets to accommodate different finger sizes in one device. The device may include at least 1 fingerlet, at least 2 fingerlets, at least 3 fingerlets, at least 4 fingerlets, or at least 5 fingerlets. In some examples, the fingerlets may be operable to accommodate finger lengths of about 1 inch, about 2 inches, about 3 inches, or about 4 inches. In other examples, the fingerlets may be operable to accommodate finger widths of about 0.4 inches, about 0.5 inches, about 0.6 inches, or about 0.7 inches. In at least one example, the fingerlets may each have a length of about 2-3 inches and a width of about 0.5-0.6 inches. Each of the fingerlets reversibly attaches to one of the extending elements 106. In at least one example, this may be accomplished by using magnetic button snaps, as seen in FIG. 7. The magnetic attachment may be preferred in patients who experience spasms in the hand that result in swift contraction of the fingers. Magnetic button snaps allow the fingerlets 104 to easily detach from the extending elements 106 when such a spasm occurs, preventing injury to the patient's fingers.

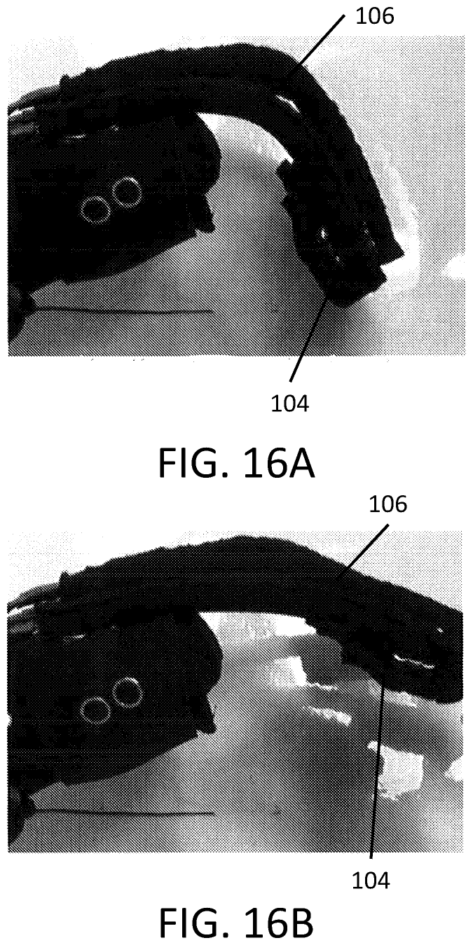

As seen in FIGS. 16A-16B, a plurality of extending elements 106 operates to extend the fingers when power is supplied to the device. The extending elements 106 are each attached to both the rigid base 102 and to one of the plurality of fingerlets 104. The device may include at least 1 extending element, at least 2 extending elements, at least 3 extending elements, at least 4 extending elements, or at least 5 extending elements. A strong attachment mechanism may be used to keep the extending elements 106 attached to rigid base 102 during extension. In one example, the strong attachment mechanism may be a plurality of magnetic button snaps, as seen in FIG. 7.

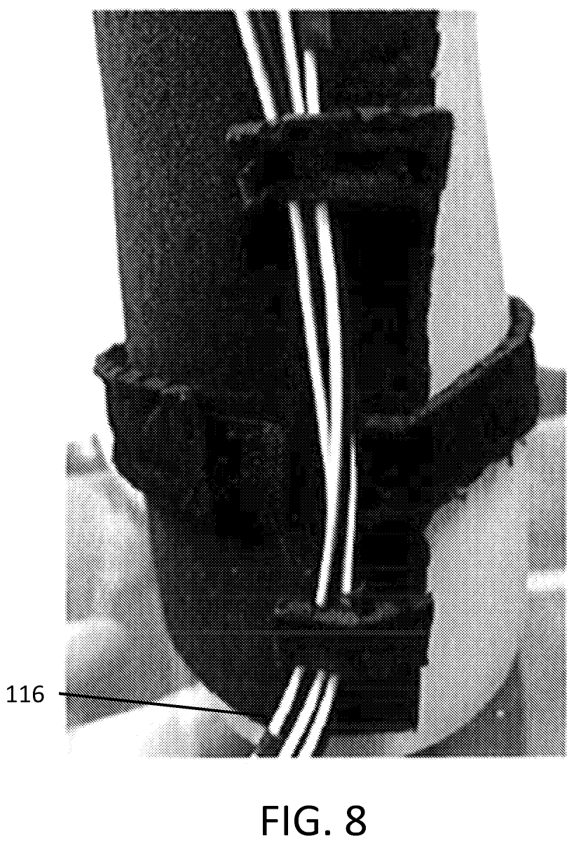

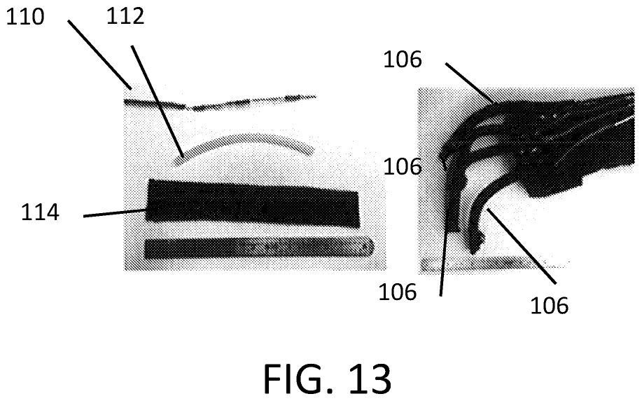

As seen in FIG. 13, the extending elements 106 may each include a shape memory alloy fiber, resistance heating wire, silicone tubing, and/or perforated neoprene. The shape memory alloy is pliable at cool temperatures, allowing it to be bent or otherwise deformed. The resistance heating wire is coiled around the shape memory alloy fiber 110. When voltage or heat is supplied to the resistance heating wire, the wire increases in temperature and causes the shape memory alloy fiber 110 to straighten. The silicone tubing 112 and perforated neoprene 114 protect and encase the resistance heating wire and shape memory alloy fiber 110, while also providing insulation. In at least one example, the shape memory alloy may be nitinol and the resistance heating wire may be nichrome. As seen in FIG. 8, the wires leading to each of the extending elements 106 may be bundled 116 and held adjacent to the rigid base with small straps comprising hook and loop fasteners. In one example, these straps are oriented such that the bundled extension wires leave the device near the patient's elbow.

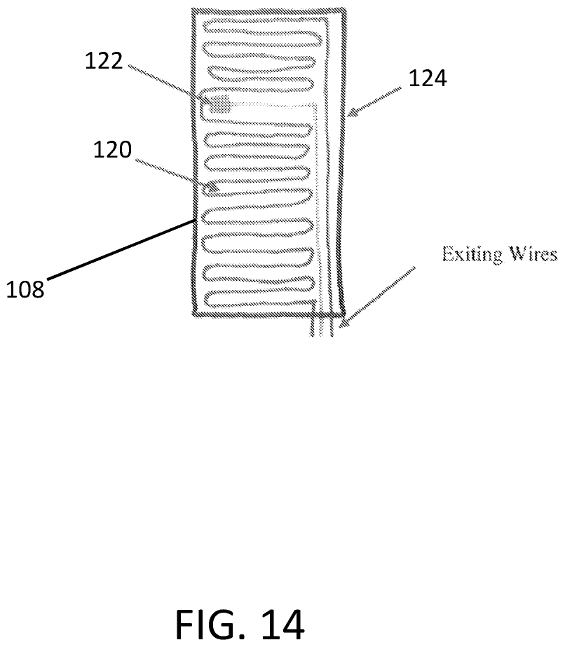

The device further includes a heating element 108 to provide therapeutic heat to the patient's forearm. As seen in FIG. 14, the heating element 108 may include a resistance heating wire 120, a resistance temperature detector 122, and/or an insulator 124. The insulator 124 may be operable to encase both the resistance heating wire and the resistance temperature detector. The resistance heating wire 120 is distributed within the insulator 124 such that it provides even heat distribution. The resistance temperature detector 122 may be placed in the insulator 124 at a location to receive the most accurate temperature reading. In an example, this may be close to the center of the heating element, where an equal length of resistance heating wire is located on either side of the resistance temperature detector. In at least one example, the resistance heating wire is nichrome and the insulator is felt.

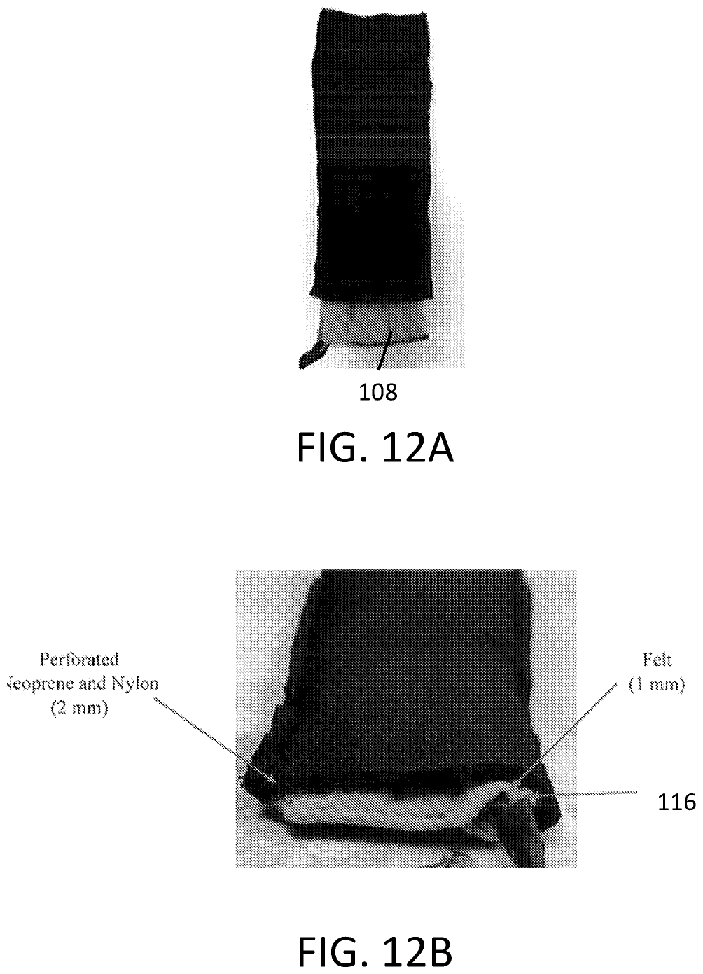

In some examples, as seen in FIGS. 12A-12B, the heating element 108 may be placed in a pouch 118 to provide further insulation and to give the heating element a sleek appearance. When the device is in use and the heating element 108 is activated, the user is likely to produce sweat which may soak into the insulation of the heating element. In an example, the pouch is washable to ensure that the device is kept clean after repeated use. This is especially important if the device is being shared among many users. In one example, this pouch is comprised of perforated neoprene and/or nylon. In at least some examples, the pouch 118 may include about 2 mm perforated neoprene and about 1 mm nylon. The pouch 118 may also include an opening for the bundle of wires 116 leading to the extending elements and/or heating element.

As seen in FIG. 6B, the heating element 108 is attached to the rigid base 102. In one example, this is accomplished by using straps comprising hook and loop fasteners located near the proximal and distal regions of the patient's forearm. In one example, the straps are sewn at one end onto a layer of perforated neoprene that is sewn onto the rigid base. The straps may also be sewn onto the insulating layer of the heating element as well as onto the rigid base 102.

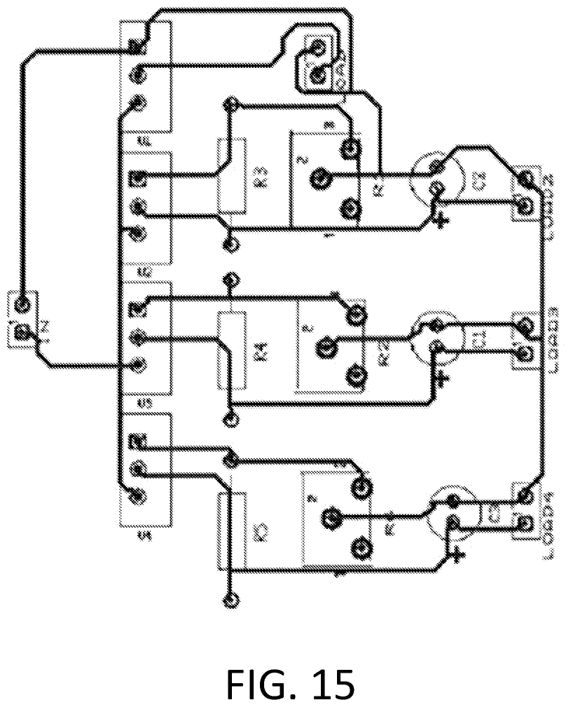

The device may further include an electrical system for supplying power to the device. FIG. 15 shows an example of an electrical system useful to operate the automated therapeutic device. In some examples the device may also include a control system. The control system may include a microprocessor, a microprocessor's port system, and/or an analog-to-digital converter. This may allow the microprocessor to control the device when the extension and heating subsystems are in use by using switches and relays connected to the microprocessor.

Further provided herein is a method for extending the curled fingers of a patient while also providing therapeutic heat. The method may include placing the device described herein on a patient's hand and supplying power to the device. The power provided to the device may extend the extending elements and/or heat the heating element. This may be accomplished by the patient or with the assistance of a caregiver.

### EXAMPLES

### Example 1: User Interface Design

The fingerlet design used an elastic perforated neoprene to accommodate the adjustability range of 0.5 to 0.6 inches in finger diameter. While it was initially expected that a Velcro adjustable strap would be needed in conjunction with the elasticity of the perforated neoprene to meet adjustability requirements, the elasticity of the material alone allowed sufficient adjustability for the user. In one example, the fingerlet was designed to be 1.3 inches in length by 1 inch in width. These dimensions were selected to ensure the fingerlet remained secured to the finger during extension.

The fingerlet releasing mechanism ensured that the tendons were immediately released from the user's finger if a rapid contracture occurred, allowing the fingers to return to a relaxed configuration. This was achieved by using magnetic button snaps to connect the finger to the extension tendons and allowed for full extension. Because every case of spasticity is different, the strength of the magnetic button snaps used should match the spasticity of the user. Disk magnets were also considered for use in the releasing mechanism, but the disk magnets tended to cause a premature release of the tendon due to the shear force created during extension.

To secure the device to the user's hand, an elastic strap stretched across the palmar region of the hand. The strap was then secured with button snaps. This configuration ensured that the rigid structure of the device was flush against the skin, allowing extension of the tendons to be fully transferred to the fingers.

The device was secured to the forearm using two Velcro straps that fixed both the rigid structure of the device and the thermal pad to the forearm.

The tendons were fixed to the device by using two button snaps. Button snaps were the preferred method for fixating the tendons because the strength of the button snaps was greater than the upward force exerted by the tendon during extension, preventing the tendon from detaching from the device when extension occurred.

Extension wires were secured to the device by using two Velcro straps made of the elastic perforated neoprene. The straps were positioned such that the extension wires left the device near the elbow.

### Example 2: Skin Contacting Material

A rigid thermoplastic material was used to support the hand. The rigidity of the thermoplastic provided the support needed for the tendons to extend the fingers to 180 degrees. The thermoplastic could also be molded to fit any hand or forearm. The thermoplastic material covered the top surface of the user's forearm and continued distally to cover the user's wrist and hand. The thermoplastic material was perforated, which allowed for comfort and breathability, particularly when the device was heated. A perforated neoprene material was sewn to the top surface of the thermoplastic to give the device a sleek appearance, and also provided a surface to place button snaps and straps to the device.

A thermal pouch contained the thermal pad that supplied heat to the forearm and acted as a barrier between the thermal pad and the skin. The thermal pad was made of perforated neoprene, which allowed the pouch to stretch when the thermal pad was inserted and ensured that the thermal pad fit tightly in the pouch. The dimensions of the thermal pad were also configured such that the thermal pad fit tightly in the pouch.

### Example 3: Extension Subsystem

The device used four tendons to extend each of the user's fingers. The tendons were comprised of nitinol fiber wrapped in insulated nichrome wire. Further, the tendons were encased in a protective silicone tube and perforated neoprene sleeve. The tendons were fixed to the user interface via button snaps. Additionally, heat-shrink tube was used to hold the fibers and wire in place as they were inserted into the silicone tube.

### Example 4: Heating Subsystem

The heating subsystem was comprised of a thermal pad that included a nichrome wire, a resistance temperature detector (RTD) that monitored the internal temperature of the thermal pad to assist in power regulation, and insulation made of felt and neoprene. The nichrome wire generated heat using electricity. The nichrome wire was configured within the thermal pad in such a manner to provide even heat distribution throughout the external surface of the thermal pad while also providing enough room for the RTD to be properly installed. The RTD was placed in between the nichrome wires with approximately the same length of wire above and below the RTD. This configuration was optimal for the RTD device to provide an accurate temperature reading. Additionally, the nichrome wires and the wires from the RTD all exited the thermal pad at the same location. This allowed the wires to be bundled together for convenience and for the user's mobility.

The thermal pad material was felt and was placed in a pocket made of perforated neoprene and nylon. The felt layer was 1 mm thick and the neoprene/nylon layer was 2 mm thick. Heat generated from the nichrome wires thus transferred through the felt layer, followed by the neoprene/nylon layer, and then to the user's arm.

### Example 5: Electrical and Control

The device was powered by electricity drawn from a wall outlet. The AC power was transformed down using a step-down transformer and a full-bridge rectifier to DC power. The DC power was then run through a regulator board to provide four different, controllable voltages required for the device to function. The voltages were 8.0 V, 5.0 V, 3.5 V, and 3.3 V.

The controls system used a microprocessor's port system and the analog-to-digital converter. This allowed the microprocessor to control the device when the extension and heating subsystems were in use by using switches and relays connected to the microprocessor.

### Example 6: Prototype Test Results

The electrical system was tested to determine whether the system would provide the required voltages of 8.0V, 3.5 V, 5.0 V, and 3.3 V to the device. The test was performed using a MU113 multimeter with an accuracy of ±2%. The multimeter leads were pressed against various points on the electrical system to read the voltage differences. Each of the required voltages was read and documented.

The extension system was tested to determine the amount of power applied to the fingers. Each tendon was bent at a 90-degree angle. The amount of time needed to straighten the tendon to a 180-degree angle was recorded. The distance traveled by the tendon was determined by multiplying the length of the tendon (4 inches) by π/4 radians (90 degrees). The maximum force exerted by each tendon was measured using a dynamometer. It was assumed that the force required to bend the tendon from 180 degrees to 90 degrees was the same force exerted when extending the tendon from 90 degrees to 180 degrees. This test showed that the device applied a maximum of 1 lbf*in/s of power to the fingers. This maximum value could be varied depending on the design of the device and the electrical input.

The thermal pad was tested to ensure it could maintain an external temperature of 110° F. (±2.5° F.) for at least 15 minutes. The room temperature during the test was 73° F. The temperature of the thermal pad was measured using a Thermocouple Thermometer HT-9815 with an accuracy of ±1° F. The probe of the thermometer was pressed to the external portion of the thermal pad that would contact the user's forearm. Power was supplied to the thermal pad to increase the temperature. Once the thermometer indicated that the temperature of the pad was 110° F., time was recorded and the temperature was monitored for 15 minutes. When the test ended, the device was turned off. The results showed that the thermal pad was able to maintain a temperature of 110° F.±4° F. for 15 minutes. The temperature ranged from 108.5° F.-113.7° F. during the test.

The thermal pad was also tested to ensure that it could maintain an external temperature of 125° F. (±2.5° F.) for at least 15 minutes. The room temperature during the test was 73° F. The temperature of the thermal pad was measured using a Thermocouple Thermometer HT-9815 with an accuracy of ±1° F. The probe of the thermometer was pressed to the external portion of the thermal pad that would contact the user's forearm. Power was supplied to the thermal pad to increase the temperature. Once the thermometer indicated that the temperature of the pad was 110° F., time was recorded and the temperature was monitored for 15 minutes. When the test ended, the device was turned off. The results showed that the thermal pad was able to maintain a temperature of 125° F.±3° F. for 15 minutes. The temperature ranged from 122.2° F.-127.4° F. during the test.

The extension and heating subsystems were tested to ensure that power to those systems could be quickly cut off by the user. The test was performed using a MU113 multimeter with an accuracy of ±2%. The leads of the multimeter were placed where the extension and heating loads run. The voltages running through the leads were recorded. The switches controlling the extension and heating loads were flipped. It took approximately one second for the multimeter to indicate the voltage dropped to 0.00V. It is noted that the multimeter specifications indicate that the multimeter changes its display every 0.5 seconds, so the voltage drop could have occurred faster than indicated.

The thermal pad was tested to determine the time it would take to reach an external temperature of 110° F. The room temperature during the test was 73° F. The temperature of the thermal pad was measured using a Thermocouple Thermometer HT-9815 with an accuracy of ±1° F. The probe of the thermometer was pressed to the external portion of the thermal pad that would contact the user's forearm. Once the thermal pad temperature was equal to the room temperature, power was supplied to the electrical subsystem and time was recorded. The thermal pad reached an external temperature of 110° F. in 49 seconds. Next, the thermal pad was tested in the same manner to determine the time it would take to reach an external temperature of 125° F. Using the same materials and methods, the results showed that the thermal pad reached an external temperature of 125° F. in 75 seconds.

The device was tested to determine if it could accommodate the proper dimensions to fit children between the ages of 4 and 11. First, the device was tested to determine if the fingerlets would accommodate fingers that were 2-3 inches in length. This was tested using a wooden articulating hand model and a ruler. The results showed that the fingerlets could not accommodate this broad range of finger length without the degrading the level of extendibility of the tendons. Thus, the fingerlets were designed to match the dimensions of the articulating hand's fingers, rather than to adjust to finger lengths of 2-3 inches. Second, the device was tested to determine if the fingerlets could accommodate finger diameters of 0.5-0.6 inches. This was tested using a wooden articulating hand model and a ruler. A single fingerlet was placed on the articulating hand's fingers having diameters of 0.5, 0.55, and 0.6 inches. The fingerlet did not slide off of the articulating hand's fingers when extension occurred. This showed that the fingerlets could successfully accommodate fingers having diameters between 0.5-0.6 inches. Third, the device was tested to determine if it could accommodate a forearm length of 6-8 inches. This was tested by putting the device on a user with a forearm length of 8 inches and using the adjustable straps to secure the device to user's forearm. The device successfully fit to the user's forearm. Because the device was shorter than 6 inches in length, it was assumed that the device would fit a user with a forearm 6 inches long. Last, the device was tested to determine if it could accommodate a forearm with a diameter of 1.625-2 inches. The device was tested by placing it on a user with a forearm 2 inches in diameter, and then placing it on an articulating hand model with a wrist diameter of 1.3 inches. The device fit properly on both the subject and on the articulating hand model, indicating that the device would fit forearms with diameters of 1.625-2 inches.

The weight of the device was determined using a Cole-Parmer 6 kg Scale (±0.00005 pounds). The scale indicated that the device weighed 0.332 pounds.

The thermal pad was tested to determine if it could with withstand a maximum external temperature of 150° F. The room temperature during the test was 73° F. The temperature of the thermal pad was measured using a Thermocouple Thermometer HT-9815 with an accuracy of ±1° F. The probe of the thermometer was pressed to the external portion of the thermal pad that would contact the user's forearm. Power was supplied to the thermal pad to increase the temperature. Once the thermal pad reached a temperature of 150° F., a timer was started and the thermal pad continued to receive power for an additional three minutes, at which point power would be turned off. The external temperature reached a maximum of 198° F. during the test and the thermal pad showed no signs of damage.

The device was tested to determine how long it would take a user to learn how to competently operate the device. A timer was started and a person who had not seen the finished prototype was given an explanation of the device's functions and how the device could be adjusted to fit the user. The person was then asked how to apply heat settings, how to adjust the device, and how to apply extension to the fingers. Once the person gave correct answers to each of the prompts, the timer was stopped. The results indicated that it took the person 3 minutes and 39 seconds to learn how to competently operate the device.

The device was tested to determine how long it would take a user to correctly put on the device with the assistance of a caregiver. A timer was started and the device was given to a user. The user and a caregiver worked to put the device on the user's hand. Once it was verified that the device was properly placed on the user's hand and forearm, the timer was stopped. The results showed that the device could be properly placed on a user's hand with the help of a caregiver in 1 minute and 52 seconds.

The device was tested to determine the level of noise made by the device while being used. The noise level was determined using a data logging sound meter (±0.05 dBC). The device was placed on an articulating hand model and power was supplied to the device. Sound measurements were taken for 10 seconds with the device placed one foot away from the sound meter. The results indicated that the device operated at 42 dBC at one foot away.

What is claimed is:

1. A therapeutic device for heating and extending a patient's curled fingers, the device comprising:
a rigid base extending from a patient's hand to elbow;
a plurality of fingerlets, each operable to attach to a finger of the patient;
a plurality of extending elements, each extending element operable to reversibly attach to the rigid base and reversibly attach to one of the plurality of fingerlets; and
a heating element operable to reversibly attach to the rigid base and distribute heat along the patient's anterior forearm.

2. The therapeutic device of claim 1, wherein the rigid base comprises a thermoplastic splinting material and perforated neoprene.

3. The therapeutic device of claim 2, wherein the thermoplastic splinting material is perforated.

4. The therapeutic device of claim 1, wherein each of the plurality of extending elements is attached to the rigid base with button snaps.

5. The therapeutic device of claim 1, wherein each of the plurality of extending elements are attached to one of the plurality of fingerlets by a magnet.

6. The therapeutic device of claim 1, wherein the heating element is enclosed in a thermal pouch.

7. The therapeutic device of claim 6, wherein the thermal pouch comprise perforated neoprene and nylon.

8. The therapeutic device of claim 1, wherein each of the plurality of extending elements comprises:
a shape memory alloy fiber;
an insulated resistance heating wire operable to coil around the shape memory alloy fiber;
a silicone tubing operable to encase the shape memory alloy fiber and the insulated resistance heating wire; and
perforated neoprene operable to encase the silicone tubing.

9. The therapeutic device of claim 8, wherein the shape memory alloy is nitinol.

10. The therapeutic device of claim 8, wherein the insulated resistance heating wire is nichrome.

11. The therapeutic device of claim 1, wherein each of the plurality of fingerlets comprises perforated neoprene.

12. The therapeutic device of claim 1, wherein the heating element comprises:
a resistance heating wire;
a resistance temperature detector operable to determine the temperature of the resistance heating wire; and
an insulator operable to encase the resistance heating wire and the resistance temperature detector.

13. The therapeutic device of claim 12, wherein the insulator is felt.

14. The therapeutic device of claim 12, wherein the resistance heating wire is nichrome.

15. The therapeutic device of claim 1, wherein the heating element is attached to the rigid base using a hook and loop fastener.

16. The therapeutic device of claim 1, wherein the heating element generates heat using electricity.

17. The therapeutic device of claim 1, wherein the rigid base is shaped such that the rigid base begins at the posterior base of a patient's elbow and continues distally on the posterior side of a patient's forearm before terminating at the top of the posterior palmar region of a patient's hand and leaves the anterior side of a patient's forearm exposed.

18. The therapeutic device of claim 1, wherein the plurality of extending elements are attached to the rigid base near the top of the posterior palmar region of a patient's hand.

19. A method for extending a patient's curled fingers and therapeutically applying heat to the patient's forearm comprising:
placing an automated therapeutic device on a patient's hand, the device comprising:
a rigid base extending from a patient's hand to elbow;
a plurality of fingerlets, each operable to attach to a finger of the patient;
a plurality of extending elements, each extending element operable to reversibly attach to the rigid base and reversibly attach to one of the plurality of fingerlets; and
a heating element operable to reversibly attach to the rigid base and distribute heat along the patient's anterior forearm; and
supplying power to the device sufficient to cause the plurality of extending elements to extend the patient's fingers.

20. The method of claim 19, wherein the plurality of extending elements comprises:
a shape memory alloy fiber;
an insulated resistance heating wire operable to receive electricity, wherein the resistance heating wire is coiled around the shape memory alloy fiber;
a silicone tubing operable to encase the shape memory alloy fiber and the insulated resistance heating wire; and
perforated neoprene operable to encase the silicone tubing.
